(19) United States
(12) Patent Application Publication
(10) Pub. No.: US 2011/0238317 A1
(43) Pub. Date: Sep. 29, 2011

(54) System for forecasting outcomes of clinical trials

(76) Inventor: Immanuel Freedman, Harleysville, PA (US)

(21) Appl. No.: 12/176,391

(22) Filed: Jul. 20, 2008

Related U.S. Application Data
(60) Provisional application No. 60/954,865, filed on Aug. 9, 2007.

(51) Int. Cl. G06F 19/00

(52) U.S. Cl. 702/19

(57) ABSTRACT

A system for forecasting outcomes of clinical trials including a digital computer having a central processor, a programmable graphical or programmable analog coprocessor in communication with the central processor, interface software in communication with the central processor and coprocessor, modeling software having simulation capability substantially executed by the central processor and in communication with the interface software, integration software substantially executed by the central processor in communication with the modeling software, partial derivative software substantially executed by the coprocessor and in communication with the interface software, a historical clinical trial data component, a model data component specifying the time course of a clinical observation by a differential equation, and a protocol data component specifying the characteristics of a population intended to undergo a future clinical trial, all the said data components in communication with the modeling software.

### CROSS REFERENCE TO RELATED APPLICATIONS

This application claims priority from application Ser. No. 60/954,865, filed Aug. 9, 2007. The entire disclosure of the aforementioned related application is hereby incorporated by reference.

### FIELD OF THE INVENTION

The invention relates to systems and methods for developing statistical models to describe and forecast the outcome of clinical trials, and more particularly to describe and forecast the outcome of clinical trials of medicines such as drugs, biologics and medical devices.

### BACKGROUND

While analyzing data about real world clinical trials, it is useful to develop statistical models to describe and forecast the outcome of clinical trials.

Pharmacokinetic (PK) statistical models describe and forecast effects that human or animal bodies have on medicines. Pharmacodynamic (PD) statistical models describe and forecast effects that medicines have on human or animal bodies. Pharmacokinetic/Pharmacodynamic (PK/PD) statistical models describe and forecast effects that human or animal bodies have on medicines together with effects that medicines have on human or animal bodies. Population PK, PD and PK/PD statistical models describe and forecast such effects in populations of individual human or animal bodies, while accounting for variability of such effects among individuals of the population.

Consider a typical population statistical model for PK, PD or PK/PD compartmental analysis, for which the population modeling software is intended to search for the value of parameters which maximize the likelihood or an approximation to the likelihood. In the document “Nonlinear Mixed Effect Models,” retrieved on Aug. 6, 2007 from the Internet URL http://www4.stat.ncsu.edu/˜davidian/nlmmtalk.pdf, Davidian, M. explains that the data are repeated measurements on each of m individual subjects, yᵢⱼ response at j th “time” tᵢⱼ for subject i, uᵢ vector of additional conditions under which subject i is observed, αᵢ vector of characteristics for subject i, where i=1, . . . , m; j=1, . . . , nᵢ; yᵢ=(yᵢ₁, . . . , yᵢₙ_{ᵢ})^{T}, and (yᵢ,uᵢ,αᵢ) are independent across i. For example, yᵢⱼ is a drug concentration for subject i at a time post-dose, uᵢ=Dᵢ the dose administered to subject i at “time” zero, and αᵢ contains subject characteristics (covariates) such as weight, age, or renal function. The model comprises a subject-level model and a population-level model. Equation 1 specifies a typical subject-level model, where ƒ is a function governing within-subject behavior, θᵢ is a p×1 vector of parameters of ƒ specific to subject i, and εᵢⱼ represents unexplained variation of observations within subjects. Typically, the statistical expectation E(εᵢⱼ|uᵢ,θᵢ)=0.

yᵢⱼ=ƒ(tᵢⱼ,uᵢθᵢ)+εᵢⱼ; i=1, . . . , m; j=1, . . . , nᵢ (1)

Equation 2 specifies a population-level model, where d is a p-dimensional function, β is an r×1 vector of fixed effects, and ηᵢ is a k×1 vector of random effects.

βᵢ=d(αᵢ,β,ηᵢ) (2)

The population-level model specifies how the elements of βᵢ vary between subjects due to systematic association with covariate αᵢ (modeled by β) and unexplained variation of observations between subjects (represented). The variance-covariance matrix of εᵢⱼ is typically denoted by Σ and the variance-covariance matrix of ηᵢ, is typically denoted by Ω. One cause of variation of response between subjects is polymorphism caused by mutation of a subject's deoxyribonucleic acid (DNA) sequence.

Csajka, C. and Verotta, D. review history and perspectives of PK/PD statistical modeling in the Journal of Pharmacokinetics and Pharmacodynamics, Vol. 33, No. 3, June 2006, pp. 227-279 (“Csajka & Verotta 2006”). Bauer, R. J., Guzy, S. and Ng, C. survey analysis methods and software for complex population PK and PD statistical models in the AAPS Journal 2007:9(1) Article 7, pp. E60-E83 (“Bauer, Guzy and Ng 2007”).

The above-referenced publications point out a long-felt need for accelerating the solution of statistical models represented by differential equations. In particular, quoting Csajka and Verotta (2006), p. 270:
“Computational limitations are severe: a simple PK/PD population model combined with a modestly sized data set can easily generate computation times of the order of days or weeks, using any of the fastest desktop computer CPU available. Similarly, relatively complex models cannot be developed with investing exorbitant amount of times. For example, for a complex HIV-1 model, keeping track of different viral sub-populations, the number of differential equations quickly becomes intractable for all practical purposes.”

Bauer, Guzy and Ng (2007) point out software-based methods that provide approximate solutions less computationally expensive than exact solutions of statistical PK/PD population models including a First Order Conditional Estimation (FOCE) method and a First Order (FO) method embodied in digital computer software such as NONMEM, currently available from Globomax, Inc. These approximate methods result in inaccuracies arising from linearizing a statistical problem.

In recent years, attempts have been made to increase the accuracy of solutions to statistical models by methods such as Expectation Maximization (EM) and Iterative Two-Stage (ITS), implemented in digital computer software such as P-PHARM, currently available from Kinetica, Inc., and PDx-MCPEM, currently available from Globomax, Inc. A Three Stage Hierarchical/Bayesian method provides a comprehensive analysis of population PK, PD and PK/PD clinical trial data together with the ability to study the profile of an entire set of likely population statistical model parameters. The Three Stage Hierarchical/Bayesian method is computationally expensive when implemented by Monte Carlo Markov Chain methods in digital computer software such as WinBUGS using the PKBUGS software interface that operates within the WinBUGS software currently available by Internet software download from http://www.mrc-bsu.cam.ac.uk/bugs/.

A drawback to using approximate solutions such as the FOCE and FO estimation methods implemented in Version 6 of the NONMEM digital computer software is the need to find good approximations to initial values of statistical model parameters so that the estimation method will converge to a pharmacologically acceptable solution.

### BRIEF DESCRIPTION OF DRAWINGS

FIG. 1 shows an exemplary embodiment of a system for forecasting outcomes of clinical trials.

FIG. 2 shows another exemplary embodiment of a system for forecasting outcomes of clinical trials.

### DETAILED DESCRIPTION

An exemplary embodiment of the invention is an apparatus and method implemented by software intended for at least one Digital Graphical Processor Unit (GPU) in digital communication with at least one digital computer, intended to accelerate the solution of statistical model differential equations by solving such equations with at least one Digital Signal Processor (DSP).

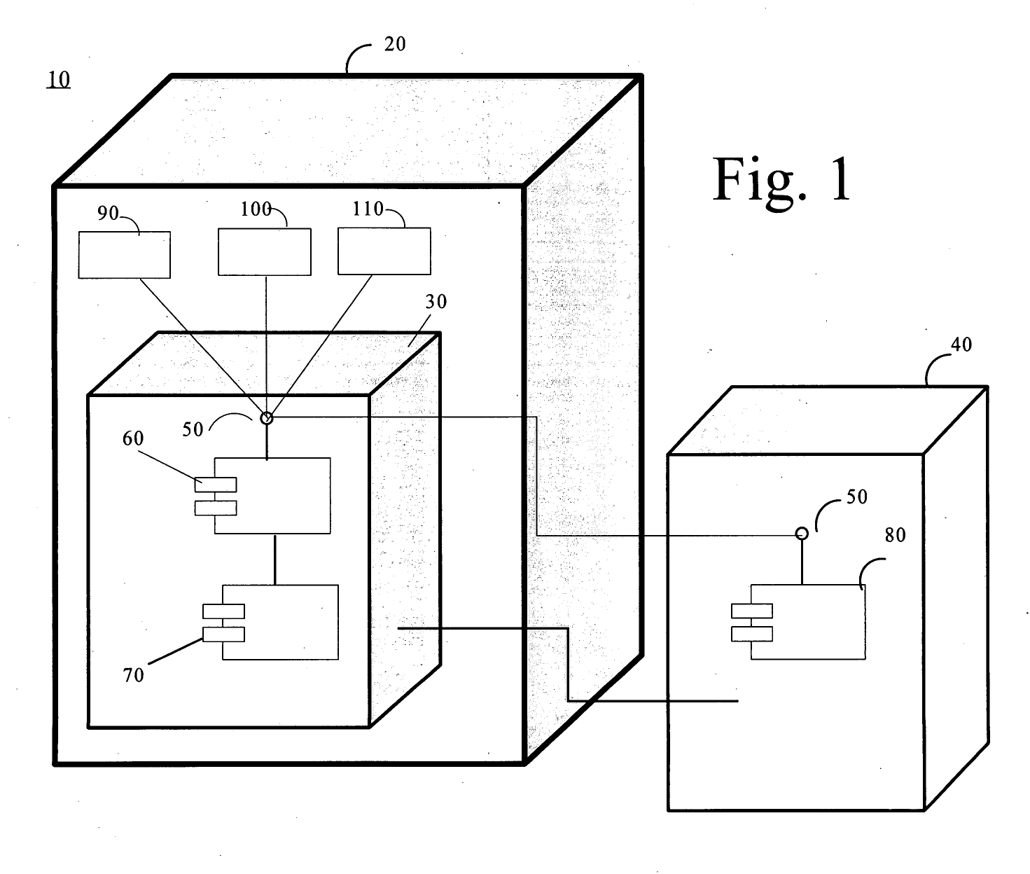

In the presently preferred embodiment of the invention, FIG. 1 shows a system 10 for forecasting outcomes of clinical trials, comprising at least one digital computer 20 comprising at least one central processor unit 30; at least one coprocessor unit 40 selected from the group consisting of programmable graphical processor unit and programmable analog processor unit and combinations thereof, in communication with the at least one central processor unit 30; at least one interface software component 50 in data communication with at least one central processor unit 30 and the at least one coprocessor unit 40; at least one modeling software component 60 having a simulation capability, the modeling software component 60 substantially executed by the at least one central processor unit 30 and in data communication with the at least one interface software component 50; at least one integration software component 70 substantially executed by the at least one coprocessor unit 40, the at least one integration software component 70 in data communication with the at least one modeling software component 60; at least one partial derivative software component 80 substantially executed by the at least one coprocessor unit 40 and in data communication with the at least one interface software component 50; at least one historical clinical trial data component 90 comprising the time course of at least one historical clinical observation, the historical clinical trial data component 90 in data communication with the at least one modeling software component 60; at least one model data component 100 specifying the time course of at least one clinical observation by at least one differential equation, the model data component 100 in data communication with the at least one modeling software component 60; and at least one protocol data component 110 specifying the characteristics of a population of subjects intended to undergo a clinical trial, the protocol data component 110 in data communication with the at least one modeling software component.

In the presently preferred embodiment the at least one digital computer 20 is a TOSHIBA SATELLITE X205™ laptop computer. The at least one CPU 30 is an INTEL DUO CORE™ CPU with onboard Arithmetic Logic Unit, each core rated at about 1.8 GHz with about 2 GB of physical memory, together associated storage peripherals such as external hard disk drives marketed by 10 Mega, Inc. The at least one GPU 40 is a GEFORCE 8™ series GPU marketed by nVIDIA, Inc. The at least one modeling software component 60 is a mixed effect modeling program such as NONMEM™ Version 6, currently marketed by Globomax, Inc., P-PHARM™, currently marketed by Kinetica, Inc., PDx-MCPEM™, currently marketed by Globomax, Inc., or the PKBUGS™ software interface to the WinBUGS™ software system currently available by download from the Internet Uniform Resource Locator (URL) designated by http://www.mrc-bsu.cam.ac.uk/bugs/.

The at least one interface software component 50 adapts software calls made by the at least one modeling software component 60 to differential equation solvers intended for execution on the CPU 30 to calls to differential equation solvers intended for execution on the GPU 40.

The at least one interface software component 50 can be developed in at least one higher level programming language such as a Common Object Request Broker (CORBA) Interface Description Language (IDL), MATLAB™, currently marketed by Mathworks, Inc., a High Level Shading Language currently distributed by Microsoft, Inc., a Cg or Compute Unified Device Architecture (CUDA™) graphical shading language currently distributed by nVIDIA, Inc., the Brook stream programming language developed by Stanford University, or the c, C++, C# or Java languages with appropriate graphical shading libraries. The at least one interface software component 50 can also be a stream processor intended to automatically convert software code initially intended for execution on the CPU 30 to software code intended for execution on a combination of the CPU 30 and the GPU 40, such as that developed by Peak Stream, Inc. or the like.

The General Purpose GPU programming repository currently located at the Internet URL designated by http://www.gpgpu.org comprises information related to software programs intended to solve differential equations on at least one GPU.

As an exemplary embodiment of the invention, the NONMEM™ Version 6 software currently invokes the following subroutines to solve differential equations as and when appropriate:

(a) DVERK1, a Runge-Kutta fifth and sixth order method intended to solve non-stiff differential equations,
(b) DGEAR1, a variable order Adams predictor-corrector method or Gear method intended to solve stiff differential equations, or
(c) LSODI1, a Livermore implicit method intended to solve differential-algebraic equations.

Each of the above subroutines is intended to solve a set of differential equations over at least one integration time interval subdivided into discrete time steps. Assuming that the subjects do not interact directly or indirectly with each other, the set of equations describing the time course of observations for each subject is independent of the set of equations describing the time course of observations for any other subject, hence the task of solving the equations may be parallelized by subject for at least one GPU 40 in communication with at least one CPU 30.

The interface software component 50 can allocate software components intended to solve the set of differential equations for the population average model between the at least one CPU 30 and the at least one GPU 40. Consider the currently available NONMEM™ Version 6 software when compiled with the INTEL FORTRAN COMPILER™ Version 10 and linked in the MICROSOFT VISUAL STUDIO™ 2005 environment. An exemplary performance analysis obtained using the INTEL VTUNE™ Performance Analyzer Version 9 on a COMPAQ EVO N800V™ laptop computer with PENTIUM™ 4 processor and 2 GB of physical memory indicates that, when the ADVAN6 subroutine is invoked to solve models specified by statistical differential equations, the NONMEM™ Version 6 software typically spends about 55% CPU time obtaining statistical model partial derivatives (FCN1 and DES subroutines), about 30% CPU time in numerical integration (DVERK1), and about 15% CPU time in other subroutines.

ACCELERANT™, currently marketed by Aspeed, Inc. is a “brute force” parallelization tool for accelerating software programs on dual-core, dual processor, and networked systems. Note that, according to the document “ACCELERANT™ Significantly Reduces NONMEM™ 5.1 Models Run Times”, retrieved on Aug. 8, 2007 from Internet URL designated by http://www.aspeed.com, Apeed, Inc. reports that, unlike the performance analysis results disclosed above, NONMEM™5.1 spends significant CPU time in the OBJ subroutine, a subroutine that calculates an objective function based on data contributed by observations on a plurality of subjects. The above referenced document, attributed to Aspeed, Inc., indicates an execution performance improvement of up to about 3.4 on an INTEL™ dual-core processor.

The DES subroutine calculates analytic partial derivatives for contribution to the total time derivative of compartmental amounts yᵢ at “time” t with population parameters uⱼ according to Equation 3. These analytic partial derivatives can be calculated in parallel.

$$\frac{\partial }{\partial {y}_{j}} ( \frac{d {y}_{i}}{d t} ) , \\ \frac{\partial }{\partial {u}_{j}} ( \frac{d {y}_{i}}{d t} ) \qquad ( 3 )$$

The FCN1 subroutine updates the total time derivative of compartment amounts yᵢ at “time” t from the analytic partial derivatives reported by the DES subroutine and calculation of the contribution from currently active and recently terminated infusions. These values can be calculated in parallel, although the FCN1 subroutine currently programmed in NONMEM™ Version 6 requires some software branching and looping.

The DVERK1 subroutine integrates the population compartment amounts over at least one integration time interval between system event times such as times associated with dosing or observing subjects. DVERK1 divides the time interval into a plurality of discrete time steps, adjusting the size of the time step based on total time derivatives reported by the FCN1 subroutine to ensure that calculated population compartment amounts yᵢ are accurate to within specified error limits, such as relative error limits specified in terms of required number of significant digits. The DVERK1 subroutine calculates the population compartment amounts yᵢ at time step TSTART+DT by combining values of the population compartment amounts currently calculated for neighboring time steps according to a weighting formula. The calculations can be performed in parallel, although the DVERK1 subroutine currently programmed in NONMEM™ Version 6 requires some software branching and looping.

The document “High Performance Direct Gravitational N-body Simulations on Graphic Processing Units II.: An implementation in CUDA™”, indexed as arXiv:0707.0438v2 [astro-ph] Jul. 16, 2007, retrieved on Aug. 7, 2007 from Internet URL http://ww.arxiv.org, Belleman, R. G., Bedorf, J. and Zwart, S. F. P. (“Belleman et al. 2007”) reports simulations in which the task of numerical integration is allocated to a CPU and the task of calculation of the gravitational force between particles is parallelized and allocated to an NVIDIA 8800 GTX™ GPU.

The document “The GPU as a high performance computational resource”, authored by Dokken, T., Hagen, T. R., and Hjelmervik, J. M., presented at SCCG 2005, May 12-14, 2005 in Budmerice, Slovakia, retrieved from Internet URL designated by http://www.gpgpu.org on Aug. 7, 2007 (“Dokken et al. 2005”) reports vertex and fragment shaders for heat partial differential equations and linear wave partial differential equations developed in the Cg graphical programming language.

The NVIDIA GEFORCE™ 8 series GPU, currently marketed by nVidia, Inc. supports single precision 32-bit arithmetic while the laptop computer CPU supports double precision 64-bit arithmetic. Many authors report that methods of numerical analysis in parallel implementations intended to be executed on currently available GPUs may execute about 10 to about 15 times faster than similar methods in sequential implementation intended to be executed on currently available CPUs. Numerical integration is typically more susceptible to rounding error than computation of partial derivatives, hence an exemplary embodiment of the invention may result in a factor of about 2 faster execution by allocating the at least one integration software component 70 to the at least one CPU 30 and the at least one partial derivative software component to the at least one GPU 40, wherein the dose administered to subjects can be determined with improved accuracy based on improved models intended to describe and forecast the outcome of clinical trials.

If double precision 64-bit arithmetic is implemented on the at least one GPU 40, a further exemplary embodiment of the invention may result in a factor of about 4 faster execution by allocating the step of integrating 100 and the step of computing partial derivatives 120 to the at least one GPU 40, wherein the dose administered to subjects can be determined with improved accuracy based on improved models intended to describe and forecast the outcome of clinical trials.

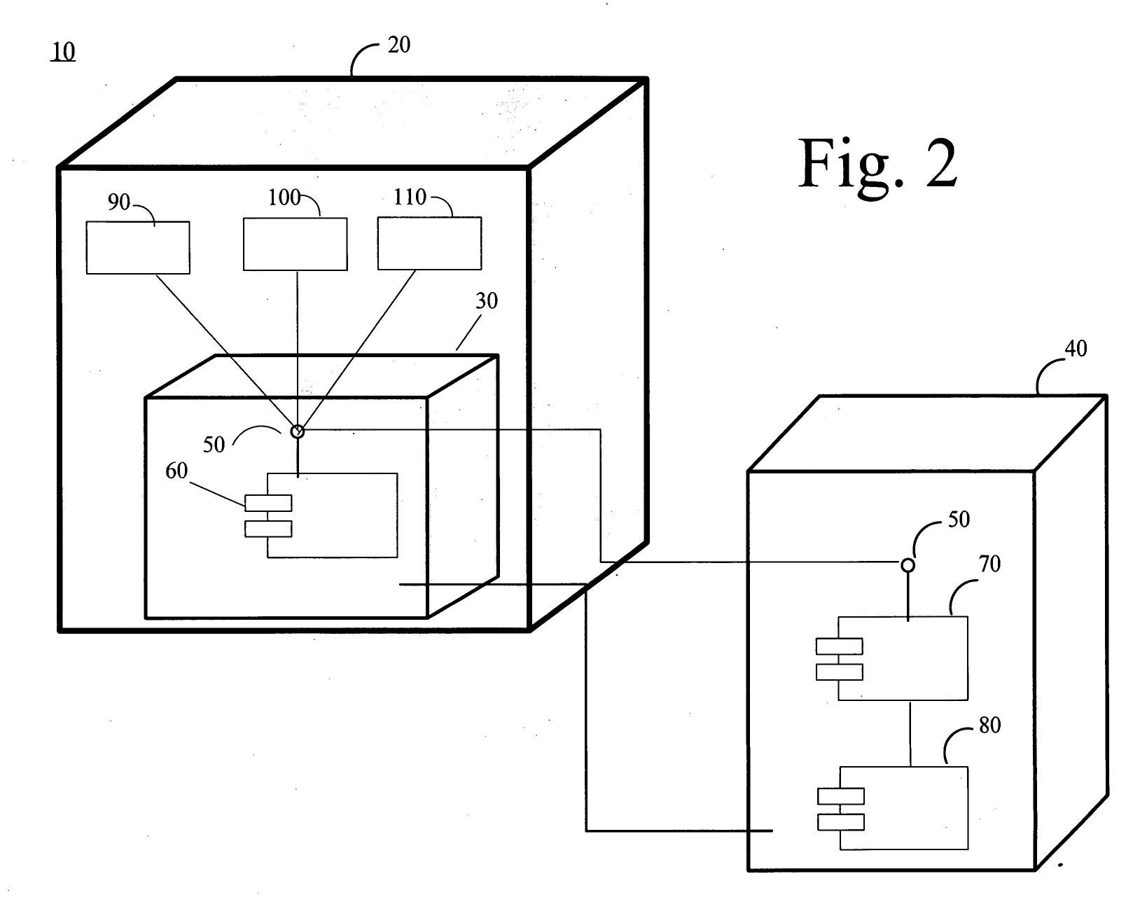

FIG. 2 shows a system 10 for forecasting outcomes of clinical trials, comprising:
at least one digital computer 20 comprising at least one central processor unit 30;
at least one coprocessor unit 40 selected from the group consisting of programmable graphical processor unit and programmable analog processor unit and combinations thereof, in data communication with the at least one central processor unit 30;
at least one interface software component 50 in data communication with at least one central processor unit 30 and the at least one coprocessor unit 40;
at least one modeling software component 50 having a simulation capability, the modeling software component 50 substantially executed by the at least one central processor unit 30 and in data communication with the at least one interface software component 50;
at least one integration software component 70 substantially executed by the at least one coprocessor unit 40, the at least one integration software component 70 in data communication with the at least one interface software component 50;
at least one partial derivative software component 80 substantially executed by the at least one coprocessor unit 40 and in data communication with the at least one integration software component 50;
at least one historical clinical trial data component 90 comprising the time course of at least one historical clinical observation, the historical clinical trial data component 90 in data communication with the at least one modeling software component 60;
at least one model data component 100 specifying the time course of at least one clinical observation by at least one differential equation, the model data component 100 in data communication with the at least one modeling software component 60; and
at least one protocol data component 110 specifying the characteristics of a population of subjects intended to undergo a clinical trial, the protocol data component 110 in data communication with the at least one modeling software component 60.

If single precision 32-bit arithmetic is implemented on the at least one GPU 40, then a further exemplary embodiment of the invention results in a factor of about 2 to about 4 faster execution by allocating the at least one integration software component 70 to the at least one GPU 40 using single precision arithmetic and the at least one partial derivative software component 80 to the at least one GPU 40 using single precision arithmetic, to provide an interim solution 120. The interim solution 120 can provide a starting approximation to a final solution 130 subsequently obtained in double precision arithmetic with the at least one integration software component 70 and the at least one partial derivative software component 80 allocated to the CPU 30.

Another exemplary embodiment of the invention is an apparatus and method implemented by software intended for at least one programmable analog processor unit (APU) in digital communication with at least one digital computer comprising at least one central processor unit (CPU), designed to accelerate the solution of statistical model differential equations by solving such equations with at least one analog processor, if the interim solution obtained by the at least one APU is sufficiently accurate to be rapidly refined to a final solution by software implemented for the at least one CPU.

In the doctoral thesis “A VLSI Analog Computer/Math Co-processor for a Digital Computer”, published by Columbia University, New York, authored by Cowan, G. E. R. (“Cowan 2005”) and in “A VLSI Analog Computer/Digital Computer Accelerator”, published in IEEE Journal of Solid State Circuits, Vol. 41, No. 1, January 2006, pp. 42-53, authored by Cowan, G.E.R., Melville, R. C., and Tsividis, Y. P. (“Cowan et al. 2006”), in order to accelerate solution of statistical models represented by differential equations, the authors suggest that differential equations may be solved with help of a digital computer operating in data communication with an analog computer implemented in accordance with Very Large Scale Integration technology. The analog computer is intended to provide an interim solution in the form of a rapid initial approximation to the statistical model differential equation. Provided the interim solution is sufficiently accurate, the initial approximation may be refined to an accurate solution under appropriate conditions by software implemented for execution by the digital computer CPU.

Cowan (2005) points out that there are many sources of inaccuracy resulting from implementation of methods by analog computers. These sources of inaccuracy include thermal, flicker and shot noise; nonlinear transfer characteristics of circuits that should be linear; imperfect operation of multipliers; output resistance of current mode circuits; offsets of variable gain amplifiers; finite Direct Current (DC) gain of integrators; input offsets of integrators; finite bandwidth of memoryless circuits; non-dominant poles of integrators; granularity of setting coefficients such as integrator time constants or gains of variable gain amplifiers, and, electrical coupling between signal wires.

In a further exemplary embodiment of the invention, the at least one APU 40 is at least one analog computer such as that described by Cowan (2005) or the like, and the digital computer 20 is a Compaq Evo n800v laptop computer with associated storage peripherals such as external hard disk drives marketed by 10 Mega, Inc. The CPU 30 is an Intel Pentium 4-M CPU with onboard Arithmetic Logic Unit, rated at about 2.0 GHz with about 2 GB of physical memory.

The exemplary embodiment of the invention based on at least one programmable APU 40 results in a factor of about 4 faster execution by allocating the integration software component 70 and the partial derivatives software component 80 to the at least one APU 60 to provide an interim solution 140 with about 1 to about 5 percent accuracy. The interim solution 140 provides a starting approximation to a final solution 150 subsequently obtained in double precision arithmetic with the step of integrating 100 and the step of computing partial derivatives 120 allocated to the CPU 20.

This implementation intended for execution on an APU is likely to converge, even for statistical differential equations with chaotic or stiff solutions, because this exemplary embodiment of the invention implements integration over a continuous integration time interval rather than an integration time interval subdivided into a plurality of discrete time intervals.

Other and further aspects of the invention will become apparent in view of the following drawings and detailed description of preferred embodiments.

1. A system for forecasting outcomes of clinical trials, comprising:
at least one digital computer comprising at least one central processor unit;
at least one coprocessor unit selected from the group consisting of programmable digital graphical processor unit and programmable analog processor unit and combinations thereof, in data communication with the at least one central processor unit to accelerate solution of statistical model differential equations by solving said equations with at least one signal processor;
at least one interface software component in data communication with at least one central processor unit and the at least one coprocessor unit;
at least one modeling software component having a simulation capability, the modeling software component having a first portion of software code executed by the at least one central processor unit and a second portion of software code executed by the said coprocessor unit, in data communication with the at least one interface software component;
at least one integration software component having a first portion of software code executed by the at least one central processor unit and a second portion of software code executed by the said coprocessor unit, the at least one integration software component, in data communication with the at least one modeling software component;
at least one partial derivative software component in data communication with the at least one interface software component;
at least one historical clinical trial data component comprising the time course of at least one historical clinical observation, the historical clinical trial data component in data communication with the at least one modeling software component;
at least one model data component specifying the time course of at least one clinical observation by at least one differential equation, the model data component in data communication with the at least one modeling software component; and
at least one protocol data component specifying the characteristics of a population of subjects intended to undergo a clinical trial, the protocol data component in data communication with the at least one modeling software component.

2. A system for forecasting outcomes of clinical trials, comprising:
at least one digital computer comprising at least one central processor unit;
at least one coprocessor unit selected from the group consisting of programmable digital graphical processor unit and programmable analog processor unit and combinations thereof, in data communication with the at least one central processor unit to accelerate solution of statistical model differential equations by solving said equations with at least one signal processor;
at least one interface software component in data communication with at least one central processor unit and the at least one coprocessor unit;
at least one modeling software component having a simulation capability, the modeling software component having a first portion of software code executed by the at least one central processor unit and a second portion of software code executed by the at least one coprocessor unit, in data communication with the at least one interface software component;
at least one integration software component having a first portion of software code executed by the at least one central processor unit and a second portion of software code executed by the said coprocessor unit, the at least one integration software component in data communication with the at least one interface software component;
at least one partial derivative software component in data communication with the at least one integration software component;
at least one historical clinical trial data component comprising the time course of at least one historical clinical observation, the historical clinical trial data component in data communication with the at least one modeling software component;
at least one model data component specifying the time course of at least one clinical observation by at least one differential equation, the model data component in data communication with the at least one modeling software component; and
at least one protocol data component specifying the characteristics of a population of subjects intended to undergo a clinical trial, the protocol data component in data communication with the at least one modeling software component.
